(19) United States
(12) Patent Application Publication
(10) Pub. No.: US 2021/0238871 A1
(43) Pub. Date: Aug. 5, 2021

(54) PORTABLE CEILING JOIST SUPPORT SYSTEM

(71) Applicants: Jason Fortson, Lakeland, FL (US); Joshua Scott Heckler, Lakeland, FL (US)

(72) Inventors: Jason Fortson, Lakeland, FL (US); Joshua Scott Heckler, Lakeland, FL (US)

(21) Appl. No.: 16/779,355

(22) Filed: Jan. 31, 2020

(51) Int. Cl. E04G 21/32; F16M 13/02

(52) U.S. Cl. CPC E04G 21/32; F16M 13/027

(57) ABSTRACT

A portable ceiling joist support system is described. In some examples, a portable ceiling joist support system can include a first shaft equipped with a first slot and a first aperture, wherein each end of the first shaft is attached to one of a first set of two brackets configured to attach to a first ceiling joist. The portable ceiling joist support system can also include a second shaft equipped with a second slot and a second aperture, wherein each end of the second shaft is attached to one of a second set of two brackets configured to attach to a second ceiling joist.

### FIELD

Some implementations relate generally to portable devices and systems for supporting equipment used and people working on ceiling joists, and more particularly, to a system/device for use on ceiling joists to hold and provide support for repairmen and/or equipment while the repairmen work on the corresponding ceiling or in the attic, as well as methods related thereto.

### BACKGROUND

Some of the existing systems and methods may not always provide adequate support to repairmen working on ceiling joists and/or in an attic. Also, existing systems and methods may not always provide a mechanism to hold and support equipment being used by such repairmen. Commonly used systems and methods for supporting repairmen and their equipment may need prior installation and may not be portable such that the repairmen can install them when needed. Examples of such systems include building a scaffolding in the attic and/or pre-installing boards or planks on ceiling joists for supporting repairmen and/or their equipment on the ceiling joists.

It may be desirable to provide new and improved portable systems and methods for providing adequate support to both repairmen working on ceiling joists and equipment being carried by the repairmen during their work such that the portable ceiling joist support systems can be carried by the repairmen and installed as and when needed. Some implementations were conceived in light of the above-mentioned limitations, needs, or problems, among other things.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations include a portable ceiling joist support system. The portable ceiling joist support system can include a first shaft equipped with a first slot and a first aperture, wherein each end of the first shaft is attached to one of a first set of two brackets configured to attach to a first ceiling joist. The portable ceiling joist support system can also include a second shaft equipped with a second slot and a second aperture, wherein each end of the second shaft is attached to one of a second set of two brackets configured to attach to a second ceiling joist. The portable ceiling joist support system can further include a flexible member connecting the first shaft to the second shaft and spanning a distance between the first ceiling joist and the second ceiling joist, wherein the flexible member is configured to support weight of one or more of a person or an equipment carried by the person.

Some implementations include a portable ceiling joist support system with a seating mechanism. The portable ceiling joist support system can include a first shaft equipped with a first slot and a first aperture, wherein each end of the first shaft is attached to one of a first set of two brackets configured to attach to a first ceiling joist. The portable ceiling joist support system can also include a second shaft equipped with a second slot and a second aperture, wherein each end of the second shaft is attached to one of a second set of two brackets configured to attach to a second ceiling joist. The portable ceiling joist support system can include a seating mechanism that is attached to the first ceiling joist and the second ceiling joist via the first and second shafts.

The seating mechanism can include a seat member and a plurality of seat support members connecting the seat member to one or more seat mechanism brackets via one of a plurality of seat support member connectors, and wherein the seating mechanism is attached to the first shaft and the second shaft via the one or more seat mechanism brackets, the first slot, the second slot, the first aperture, and the second aperture.

A method for supporting a person working on ceiling joists can include attaching a first shaft to a first ceiling joist via a first set of two brackets. The method can also include attaching a second shaft to a second ceiling joist via a second set of two brackets. The method can further include connecting a flexible member spanning a distance between the first ceiling joist and the second ceiling joist to the first shaft and the second shaft, wherein the flexible member is configured to support weight of one or more of a person or an equipment carried by the person.

### BRIEF DESCRIPTION OF THE DRAWINGS

FIG. 1 is a diagram showing a top perspective view of an example portable ceiling joist support system in accordance with some implementations.

FIG. 2 is a diagram showing a front view of an example portable ceiling joist support system in accordance with some implementations.

FIG. 3 is a diagram showing a side view of an example portable ceiling joist support system in accordance with some implementations.

FIG. 4 is a diagram showing a top perspective view of an example portable ceiling joist support system attached to example ceiling joists in accordance with some implementations.

FIG. 5 is a diagram showing a front and side perspective view of an example seating mechanism component for use with an example portable ceiling joist support system in accordance with some implementations.

FIG. 6 is a diagram showing a front and side perspective view of an example seating mechanism component for use with an example portable ceiling joist support system in accordance with some implementations.

FIG. 7A and FIG. 7B are diagrams showing side views of an example seating mechanism component for use with an example portable ceiling joist support system being affixed to a shaft of the example portable ceiling joist support system in accordance with some implementations.

### DETAILED DESCRIPTION

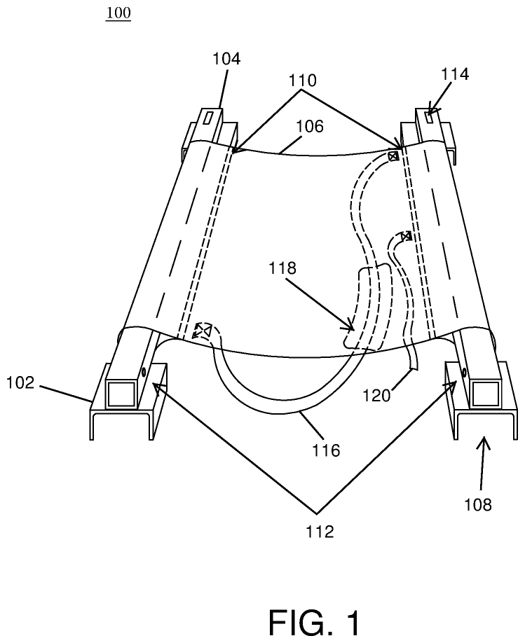

FIGS. 1-4 show diagrams of an example portable ceiling joist support system (e.g., 100) and/or components thereof. Such portable ceiling joist support systems can, for example, be used by repairmen working in an attic environment (e.g., painters or carpenters working in the attic). In FIG. 1, an example portable ceiling joist support system 100 is shown in accordance with some implementations. The portable ceiling joist support system shown includes two shafts 104, each equipped with an aperture 112 and a slot 114. The ends of each shaft are attached to brackets 102 configured to attach to a ceiling joist. The portable ceiling joist support system shown further includes a flexible member 106 connecting the two shafts and spanning a distance between two ceiling joists. The flexible member can be configured to support the weight of a person and/or an equipment carried by the person. The flexible member is attached to the two shafts as shown at 110. The brackets 102 are each shown to have a recess 108 to attach to one or more ceiling joists.

The portable ceiling joist support system can also optionally include a carrying strap 116 with a shoulder pad 118 to help carry the system when the system is collapsed for transport. The portable ceiling joist support system can also optionally include a closure strap 120 that can help secure the system in a collapsed state for storage or transport. The closure strap 120 can include fasteners (e.g., hook and loop, snaps, etc.) to secure the closure strap to itself to secure the system in a collapsed state for storage or transport.

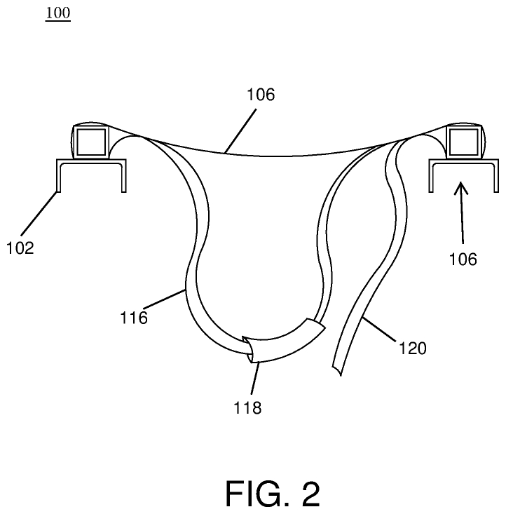

FIG. 2 shows a front view of an example portable ceiling joist support system 100 in accordance with some implementations. The portable ceiling joist support system shown in this view includes a bracket 102, a recess 108 of the bracket to attach to a ceiling joist and a flexible member 106 connecting two shafts, each of which is in turn attached to brackets 102 at each end.

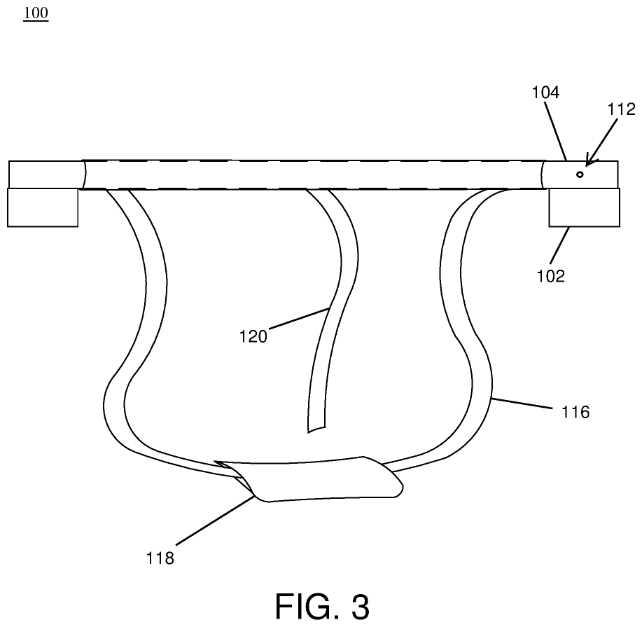

FIG. 3 shows a side view of an example portable ceiling joist support system 100 in accordance with some implementations. The portable ceiling joist support system shown in this view includes a bracket 102 attached to a shaft 104, which shaft 104 includes an aperture 112.

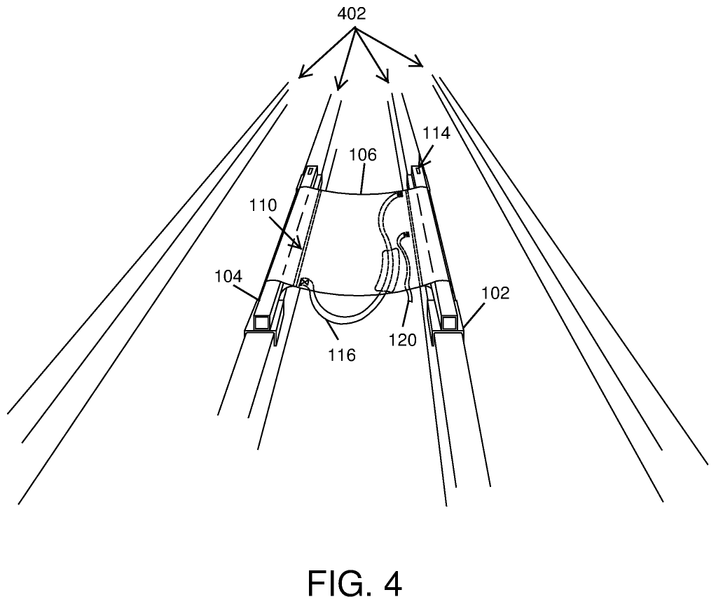

FIG. 4 shows a top perspective view of an example portable ceiling joist support system attached to example ceiling joists in accordance with some implementations. The portable ceiling joist support system shown in this view includes two shafts 104, each equipped with a slot 114. The ends of each shaft are attached to brackets 102, which are in turn attached to two ceiling joists 402. The portable ceiling joist support system shown includes a flexible member 106 connecting two shafts 104 and spanning a distance between the two ceiling joists 402. The flexible member 106 is, for example, configured to support the weight of a person and/or equipment. The flexible member 106 is connected to the two shafts as shown at 110.

In some implementations, the shaft 104 and the brackets 102 at each end of the shaft can form a single integrated unit without one or more joints, attachments, or connections. Also, in some implementations, the flexible member is of fixed width corresponding to the standard distance between ceiling joists. In some other implementations, the width of the flexible member can be varied during use in real-time based on the distance that the flexible member is required to span. In some implementations, the flexible member is pre-attached to the shafts in the portable ceiling joist support system, but in other implementations, a person can attach the flexible member to the shafts as and when required, including while working on ceiling joists.

An example process/method for supporting a person working on ceiling joists can include attaching a first shaft to a first ceiling joist via a first set of two brackets. The method can also include attaching a second shaft to a second ceiling joist via a second set of two brackets. The method can further include connecting a flexible member spanning a distance between the first ceiling joist and the second ceiling joist to the first shaft and the second shaft, wherein the flexible member is configured to support weight of one or more of a person or an equipment carried by the person.

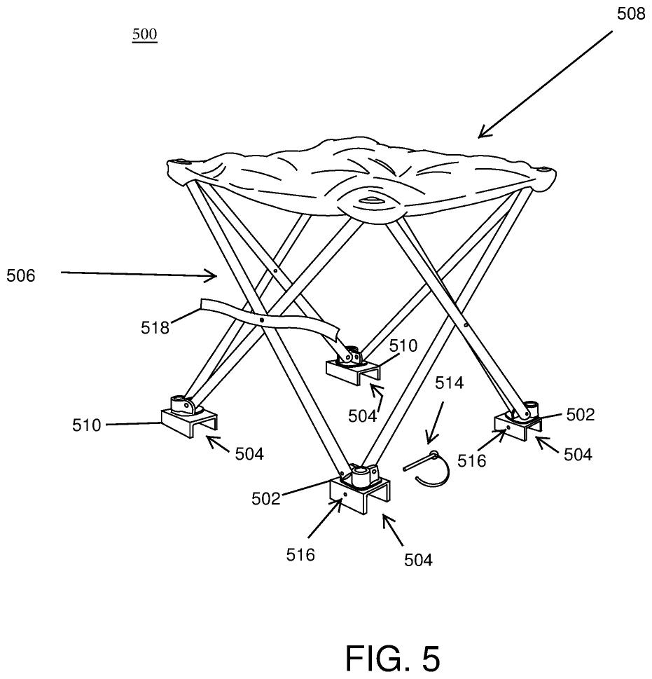

FIG. 5 shows a diagram of a front and side perspective view of an example seating mechanism 500 that is part of an example portable ceiling joist support system in accordance with some implementations. The seating mechanism shown in this view for supporting a person comprises a seat member 508 and a plurality of seat support members 506 connecting the seat member 508 to one or more seat mechanism brackets 502, 510 via one of a plurality of seat support member connectors. These seat mechanism brackets 502, 510 are shown to have a recess 504 and seat mechanism brackets 502 are shown to have apertures 516 for connecting to shafts. The seating mechanism 500 can also optionally include a strap 518 to secure the seating mechanism 500 in a closed position for storage or transport. The strap 518 can include fasteners (e.g., hook and loop, snaps, etc.) to secure the closure strap to itself to secure the seating mechanism in a collapsed state for storage or transport.

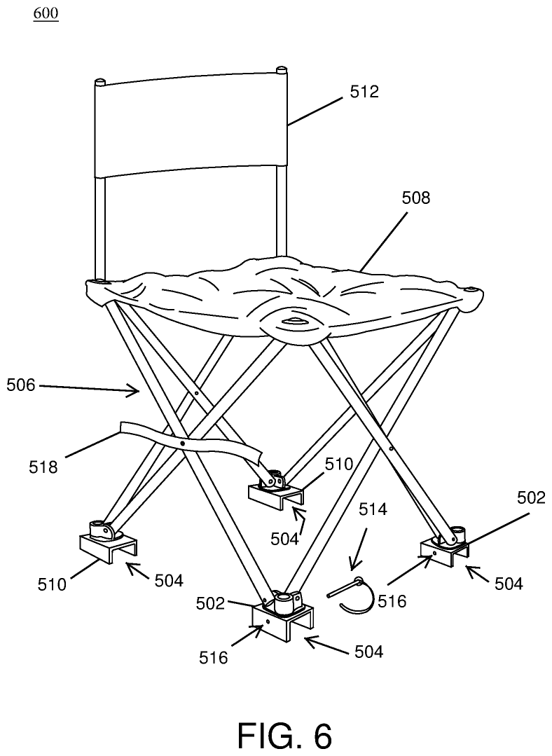

FIG. 6 shows a diagram of a front and side perspective view of an example seating mechanism (that is part of an example portable ceiling joist support system) along with a backrest 512 included with the seating mechanism in accordance with some implementations. The seating mechanism shown in this view for supporting a person comprises a seat member 508, a backrest 512 for the seat member 508, and a plurality of seat support members 506 connecting the seat member 508 to one or more seat mechanism brackets 502, 510 via one of a plurality of seat support member connectors. These seat mechanism brackets 502, 510 have a recess 504. The seat mechanism brackets 502 can be connected to shafts via locking pins 514, wherein each locking pin 514 passes through one or more apertures 516 of the bracket 502.

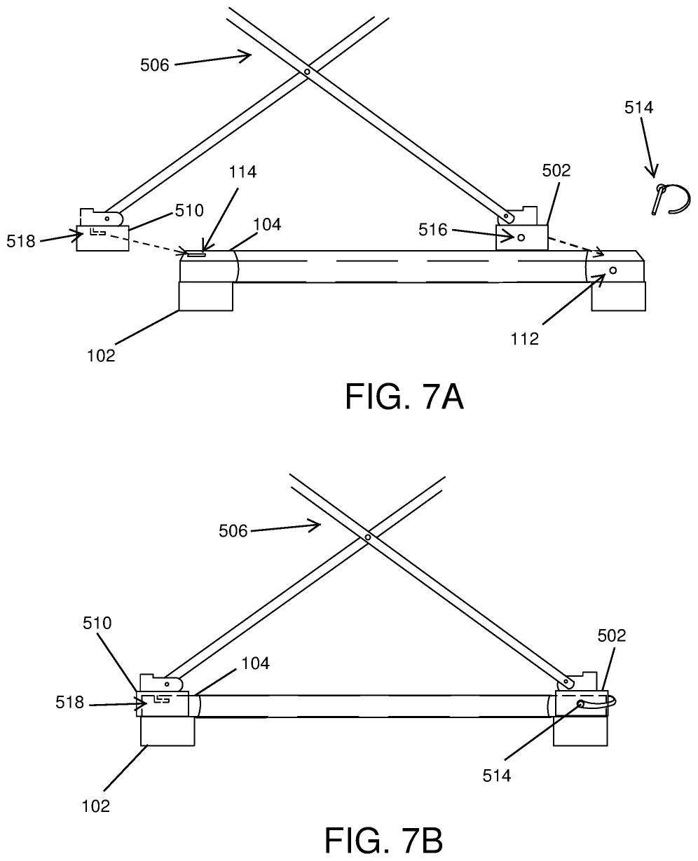

FIG. 7A and FIG. 7B show diagrams of side views of example seat mechanism brackets 502, 510 being affixed to a shaft 104 in accordance with some implementations. FIG. 7A shows the seat mechanism brackets 502 and 510 attached to seat support members 506 via seat support member connectors. In FIG. 7A, seat mechanism bracket 502 is shown with aperture 516 and the shaft 104 is shown with shaft aperture 112 with which the aperture 516 is to be aligned. FIG. 7A also displays a locking pin 514 for locking the seat mechanism bracket 502 onto the shaft 104. Also, seat mechanism bracket 510 is shown with a locking mechanism 518 and shaft 104 is shown with slot 114 with which the locking mechanism 518 is to be engaged. The shaft 104 is attached to a bracket 102, which bracket can be used in turn to attach the shaft to a ceiling joist.

FIG. 7B shows the seat mechanism bracket 502 attached to shaft 104 with aperture 516 of the seat mechanism bracket 502 aligning with aperture 112 of the shaft 104. Locking pin 514 is shown passing through the aligned shaft aperture 112 and the seat mechanism bracket aperture 516 to lock the seat mechanism bracket 502 in place on the shaft 104. Also, the seat mechanism bracket 510 is shown attached to the shaft 104 via the locking mechanism 518. In FIG. 7B, the bracket 102 is shown attached to the shaft 104, which in turn is attached to seat support members 506 via the seat mechanism brackets 502, 510, the shaft aperture 112 and slot 114 of shaft 104.

The shafts, brackets, ceiling joists, seat support members, seat members, seat mechanism brackets, and seat support member connectors can be made of materials such as wood, metal, plastics, and other natural or synthetic materials. The flexible member can be made of canvas, cloth, plastic, fiber, metal, and other natural or synthetic materials. The flexible member can take the form of a sheet, a mesh or any other suitable construction for connecting the shafts described herein. The seat member and backrest can be made of suitable materials such as foam, cloth, canvas, and fiber, and can take the form of a sheet, a mesh or any other suitable construction. Also, the backrest can be made of wood, metal, plastics, and other natural or synthetic materials. In some implementations, the backrest and the seat member can form a single integrated unit without one or more joints, attachments, or connections.

The portable ceiling joist support system can be a ceiling joist support system used by repairmen, painters, carpenters, and welders in some implementations. It will be appreciated that the portable ceiling joist support system described herein is for illustration purposes only and is not intended to be limiting. Other portable ceiling joist support systems may be used depending on a contemplated implementation. It will be appreciated that the shafts, brackets, ceiling joists, flexible members, apertures, slots, seating mechanisms, seat members, seat support members, seat mechanism brackets, and seat support member connectors described herein are for illustration purposes only and are not intended to be limiting. Other types, shapes, sizes, and materials of shafts, brackets, ceiling joists, flexible members, apertures, slots, seating mechanisms, seat members, seat support members, seat mechanism brackets, and seat support member connectors may be used depending on a contemplated implementation.

In some examples, a portable ceiling joist support system can further include a flexible member connecting the first shaft to the second shaft and spanning a distance between the first ceiling joist and the second ceiling joist, wherein the flexible member is configured to support the weight of a person and/or an equipment carried by the person. In some other examples, the portable ceiling joist support system can include a seating mechanism for supporting a person, wherein the seating mechanism comprises a seat member and a plurality of seat support members connecting the seat member to one or more seat mechanism brackets via one of a plurality of seat support member connectors, and wherein the seating mechanism is attached to the first shaft and the second shaft via the one or more seat mechanism brackets, the first slot, the second slot, the first aperture, and the second aperture.

It will be appreciated that any dimensions described herein are for illustration purposes only and are not intended to be limiting. Other dimensions could be used depending on a contemplated implementation.

It is therefore apparent that there are provided, in accordance with the various example implementations disclosed herein, portable ceiling joist support systems and methods related thereto.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

What is claimed is:

1. A portable ceiling joist support system comprising:
a first shaft equipped with a first slot and a first aperture, wherein each end of the first shaft is attached to one of a first set of two brackets configured to attach to a first ceiling joist;
a second shaft equipped with a second slot and a second aperture, wherein each end of the second shaft is attached to one of a second set of two brackets configured to attach to a second ceiling joist; and
a flexible member connecting the first shaft to the second shaft and spanning a distance between the first ceiling joist and the second ceiling joist, wherein the flexible member is configured to support weight of one or more of a person or an equipment carried by the person.

2. A portable ceiling joist support system comprising:
a first shaft equipped with a first slot and a first aperture, wherein each end of the first shaft is attached to one of a first set of two brackets configured to attach to a first ceiling joist;
a second shaft equipped with a second slot and a second aperture, wherein each end of the second shaft is attached to one of a second set of two brackets configured to attach to a second ceiling joist; and
a seating mechanism for supporting a person, wherein the seating mechanism comprises a seat member and a plurality of seat support members connecting the seat member to one or more seat mechanism brackets via one of a plurality of seat support member connectors, and wherein the seating mechanism is attached to the first shaft and the second shaft via the one or more seat mechanism brackets, the first slot, the second slot, the first aperture, and the second aperture.

3. A method for supporting a person working on ceiling joists, the method comprising:
attaching a first shaft to a first ceiling joist via a first set of two brackets;
attaching a second shaft to a second ceiling joist via a second set of two brackets; and
connecting a flexible member spanning a distance between the first ceiling joist and the second ceiling joist to the first shaft and the second shaft, wherein the flexible member is configured to support weight of one or more of a person or an equipment carried by the person.
